(19) United States
(12) Patent Application Publication
(10) Pub. No.: US 2012/0154687 A1
(43) Pub. Date: Jun. 21, 2012

(54) Multi-band tunable antenna for integrated digital television service on mobile devices

(76) Inventors: Songnan Yang, San Jose, CA (US); Ulun Karacaoglu, San Diego, CA (US); Seong-Youp Suh, Portland, OR (US); Simin Huang, Shanghai (CN)

(21) Appl. No.: 12/928,760

(22) Filed: Dec. 17, 2010

(51) Int. Cl. H01Q 1/24; H04N 5/44; H01Q 9/00

(52) U.S. Cl. 348/725; 343/750; 343/702; 348/E05.096

(57) ABSTRACT

A multi-band tunable antenna is implemented on device, where the multi-band tunable antenna supports both VHF and UHF frequencies at the same time, and particularly digital television frequencies. The multi-band tunable antenna includes a tunable component that connects metallic radiating elements. Changing the electrical property, such as capacitance, of the tunable component, changes the ability to receive particular frequencies.

### BACKGROUND

Mobile devices such as notebooks, netbooks, tablets, electronic readers, and such, can be implemented with digital television (TV) or DTV radio to receive DTV signals. The DTV signals can be received through the use of an antenna. DTV signals can be transmitted over VHF and UHF frequency bands. The VHF band can cover the 170 to 230 MHz frequency spectrum, and the UHF band can cover the 470 to 862 MHz frequency spectrum.

In order to receive such DTV signals, certain approaches include providing an antenna port to connect a device to an external antenna, and particularly to support the UHF band. However, such approaches make use of a separate antenna which can be inconvenient. Considering the relatively small size of such devices, it can be difficult to embed or include in the devices, an appropriate antenna to cover the VHF and UHF bands.

As DTV services become more and readily available, it would be desirable to provide the ability to access DTV signals by mobile devices in a convenient manner. In order to provide such ability, the implementation of an appropriate antenna should be provided to be able to receive DTV signals. However, as mentioned above, a challenge is to physically integrate an antenna that supports both VHF and UHF bands into a device.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is a block diagram of an example multi-band tunable antenna for digital television according to some implementations.

FIG. 2 is another block diagram of an example multi-band tunable antenna for digital television according to some implementations.

FIG. 3 is a graph of example combined frequency coverage of a multi-band tunable antenna for digital television according to some implementations.

FIG. 4 is a diagram of an example device that includes a multi-band tunable antenna for digital television according to some implementations.

FIG. 5 is another diagram of an example device that includes an example multi-band tunable antenna for digital television with an electrically tunable component, according to some implementations.

FIG. 6 is an example block diagram of an example device that includes a multi-band tunable antenna for digital television according to some implementations.

FIG. 7 is a flow chart for tuning a multi-band tunable antenna for DTV services, for a device, according to some implementations.

### DETAILED DESCRIPTION

### Overview

In a device receiving digital television (DTV) signals, an integrated multi-band tunable antenna that supports UHF and VHF frequencies is provided. In certain implementations, the multi-band antenna is integrated into a lid of the device.

The multi-band tunable antenna for DTV signals/services can be integrated into devices, such as notebook computers, with minimal or no impact as to form factor of the device and affect on other antennas, embedded/integrated radios, and other devices/functions of the device.

In certain implementations, a platform controller hub or PCH is modified to provide for functions related to the multi-band tunable antenna, along with a DTV wireless module. Software modifications/additions can be provided to support the hardware configurations.

### Multi-Band Tunable Antenna

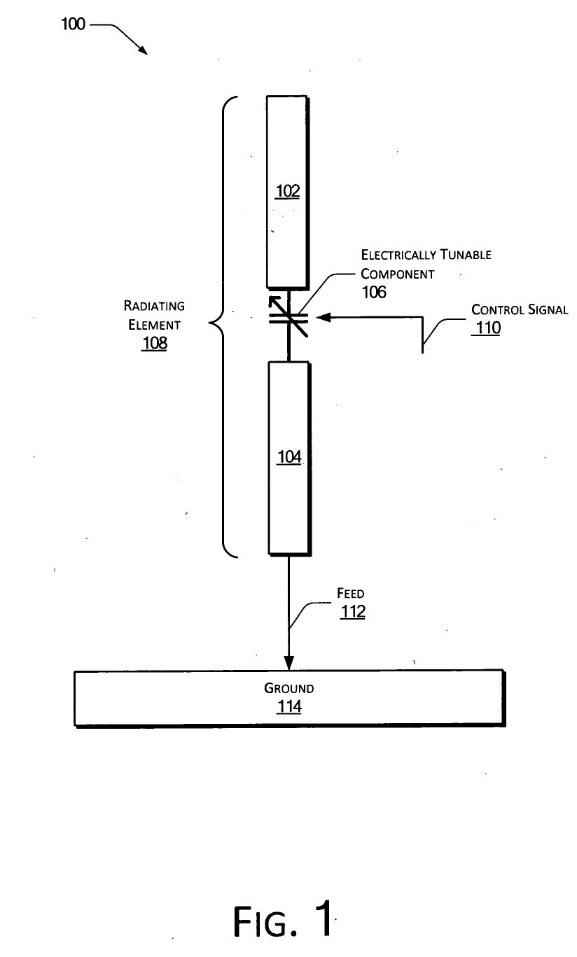

FIG. 1 shows an example multi-band tunable antenna 100 for DTV. In particular, the multi-band tunable antenna 100 supports VHF and UHF frequencies. From an antenna design perspective to support DTV signals, especially VHF frequencies, once an antenna is integrated into a device (e.g., notebook computer) chassis, metallic structures near the antenna (e.g., notebook LCD panel) can limit the antenna impedance bandwidth. As a result, it can be a challenge to integrate a conventional antenna structure into devices, in order to cover the DTV bands (i.e., UHF and VHF bands).

The multi-band tunable antenna 100 for DTV includes an element 102 and an element 106. Elements 102 and 104 are connected by an electrically tunable component 106. Collectively, elements 102 and 104, along with electrically tunable component 108 make up a radiating element 108. The signal receiving properties of radiating element 108 is determined by a control signal 110. The multi-band tunable antenna 100 further includes a feed point 112 to a ground plane or ground point 114.

The tuning elements which include elements 102, 104, and electrically tunable component 106 are placed at specific locations on the multi-band tunable antenna 100 to allow the multi-band tunable antenna 100 structure to achieve two resonances (e.g., one in UHF band and one in VHF band) and enable the multi-band tunable antenna 100 to tune the frequencies of both resonances over a broad bandwidth. Example placements are described further below.

By placing a tunable component 108, which is changed/tuned by a control signal 110, the radiating element 108 provides different resonant frequencies. As further discussed below, different frequency states are provided by adjusting the radiating element 108. An accumulation of the different states equals the frequency spectrum that is to be supported, as further discussed below. In other words, one state (i.e., tuning configuration) may cover only a small portion of a band (i.e., a few channels) in one state, but the combination of all tuning states can cover the whole band of interest (i.e., frequency spectrum).

The electrically tunable component 106 can be considered in general, as a switching device. In an example, the electrically tunable component 106 can be implemented as a varactor diode or varactor. When different voltage is applied (e.g., reverse biasing), the varactor exhibits different capacitance. In other words, the varactor can exhibit different capacitances with different applied voltages. The response of the multi-band tunable antenna 100 can in turn cover different frequency bands along with the change of varactor bias voltages. In other implementations, a MOSFET for MEMs can be used for the electrically tunable component 106.

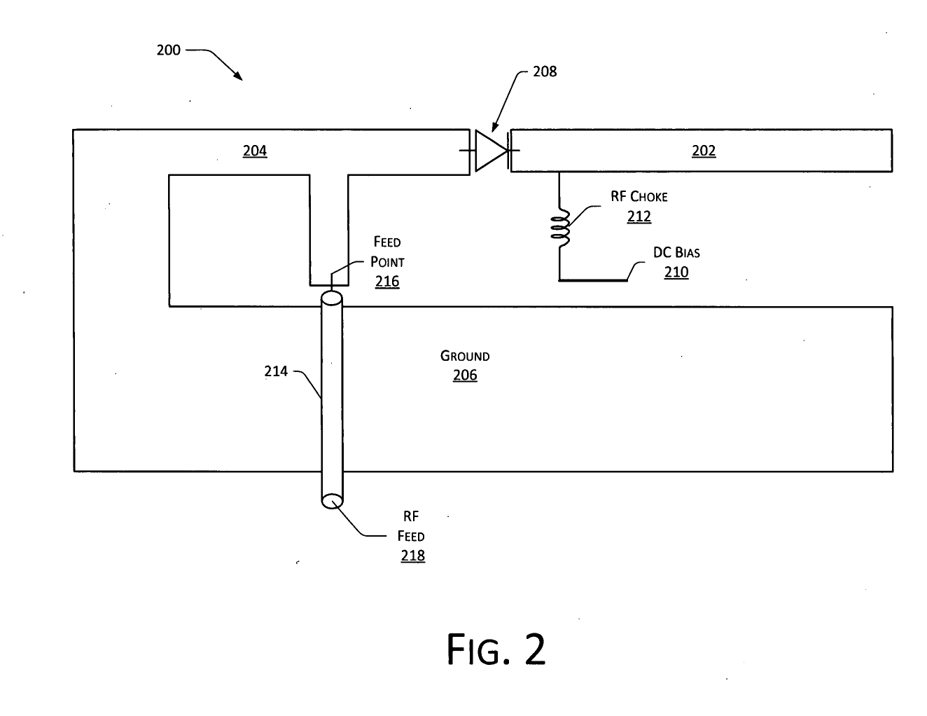

FIG. 2 shows another implementation of a multi-band tunable antenna 200. The multi-band tunable antenna 200 includes an element 202 and element 204. A varactor diode or varactor 208 acting as an electrically tunable component, connects element 202 and 204.

It is to be noted that when varactor diodes are used as a tunable capacitor (electrically tunable component), an accurate reverse bias voltage should be provided at each tunable configuration or each state as described below. An advantage of using such a varactor diode or varactor 208, is that varactor 208 operates under reverse bias, and almost no leakage current may be drawn. As a result, such a tuning element (i.e., electrically tunable component 106 and varactor 208) introduced to antennas almost contributes to no power consumption.

In FIG. 2, a biasing architecture is shown, where a negative dc bias voltage 206 is applied to the cathode of the varactor diode through a DC control line (analogous to control signal 110). An RF chock inductor 212 is added to the bias line to isolate the DC bias and RF signal on the multi-band tunable antenna 200. The anode of the varactor 208, along with the rest of the structure of the multi-band tunable antenna 200 is connected to DC ground 206 through the outer conductor of a coaxial cable 214 feeding the multi-band tunable antenna 200, where the coaxial cable 214 includes a feed point 216 and RF feed 218.

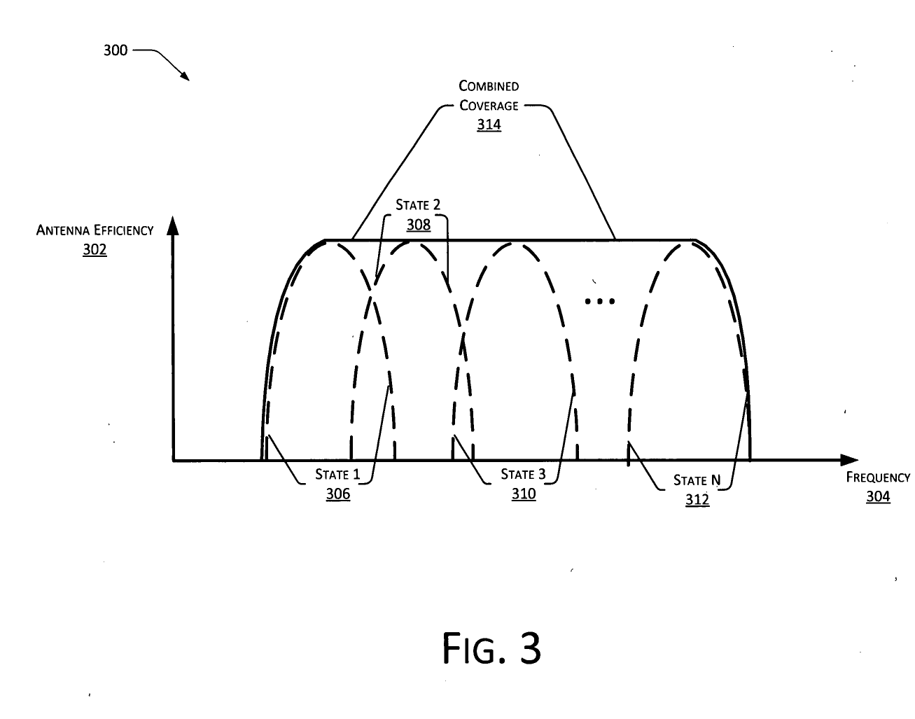

FIG. 3 shows a graph 300 that plots antenna efficiency 302 against frequency 304. As the electrically tunable component 106 or varactor 208 is changed, a different state is provided, as described above. In graph 300, there is a state 1 306, state 2 308, state 3 310, . . . and up to state N 312. For different control signals or bias voltages, as applied to tunable component 106 or varactor 208, a different frequency state for the antenna is provided. The different states provide for a combined coverage of 314. A multi-band tunable antenna can have multiple combined coverage in a few discrete frequency bands.

Therefore, each voltage bias state covers a small portion of the band while the combination of multiple states supports a much wider bandwidth than with single voltage state. A tunable multi-band antenna design is provided that is electrically tuned to dynamically receive the selected DTV channel(s) in either UHF or VHF frequency bands, or both. With the combined frequency coverage of the same antenna configured at difference tunable states, the entire DTV band in both UHF and VHF bands can be covered with good performances.

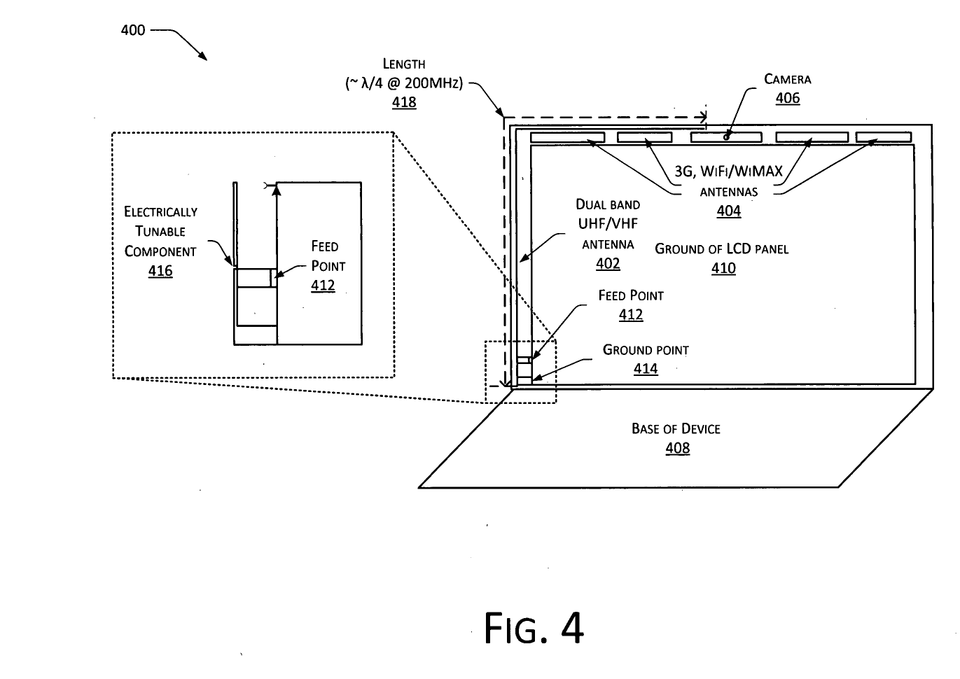

FIG. 4 shows a device 400 that includes a multi-band tunable antenna 402 for digital television service. The multi-band tunable antenna 402 can also be referred to as a multi-band tunable antenna 402. The device 400 can further include other 3G, WiFi/WiMax antennas 404, a camera 406 and other devices/components, functionality of which should not be affected by the multi-band antenna 402. The device 400 has a base 408.

As discussed above, the multi-band tunable antenna 402 supports both UHF and VHF DTV frequencies at the same time. In the implementation shown in FIG. 4, the DTV antenna or the multi-band tunable antenna 402 is placed along the left edge of the lid of device 400. A maximum dimension of the antenna is selected to have a fundamental resonance frequency in VHF band (˜200 MHz), the second resonance of the antenna can cover a portion of the UHF band (˜600 MHz), which is an implementation of how the multi-band tunable antenna 402 can constructed.

The device 400 includes a ground plane, in the form of the shielding of LCD panel 410 on the device 400 chassis. The device 400 further includes a feed point 412 and ground point 414. An electrically tunable component 416 (e.g., varactor) is included in the example of device 400. The electrically tunable component 416 (e.g. varactor) tunes both frequencies in VHF and UHF accordingly and eventually the multi-band tunable antenna 402 covers the entire DTV band.

The length 416 of the multi-band tunable antenna 402 is approximately wavelength divided by four at 200 Mhz or λ/4@200 Mhz. An example length is 37.5 cm. This is a relatively large length compared to the size of the device 400. The overall antenna length is large in order to cover the low frequency of the VHF band. In order to fit the multi-band tunable antenna 402 in the lid of the device 400, while supporting a maximum possible bandwidth at each DC biasing configuration (i.e., state), the radiating element (e.g., radiating element 108) can be arranged along the rim of the lid, either inside or outside of the chassis, of device 400. This integration methodology can provide a maximum possible separation between the multi-band tunable antenna 402 and the LCD's ground plane 410, and a broad bandwidth can be achieved in relatively small space.

In an implementation, the multi-band tunable antenna 402 is a relatively long piece of metallic structure to cover for low frequencies. Meandering applications or wrap around can be applied to fit the multi-band tunable antenna 402. As mentioned the multi-band tunable antenna 402 can be inside or outside of the chassis of the device 400. In certain implementations coating or electroplating can be applied to make a structure conductive.

The impacts of the multi-band tunable antenna 402 to other existing antennas can be minimized by considering optimum feed and grounding positions. The placement of feed point 412 and grounding point 414 location of a large antenna can play a role in determining impact to other antennas. In an implementation, arranging the feed point 412 and grounding point 414 to the bottom corner of lid of device 400, can extend the end of the radiating element (i.e., the multi-band tunable antenna 402) to the top rim of the lid without additional grounding on top of the lid of device 400. This integration arrangement minimizes the impact of the multi-band tunable antenna 402 as to any existing antennas, such as other 3G, WiFi/WiMax antennas which are placed on the top of the lid.

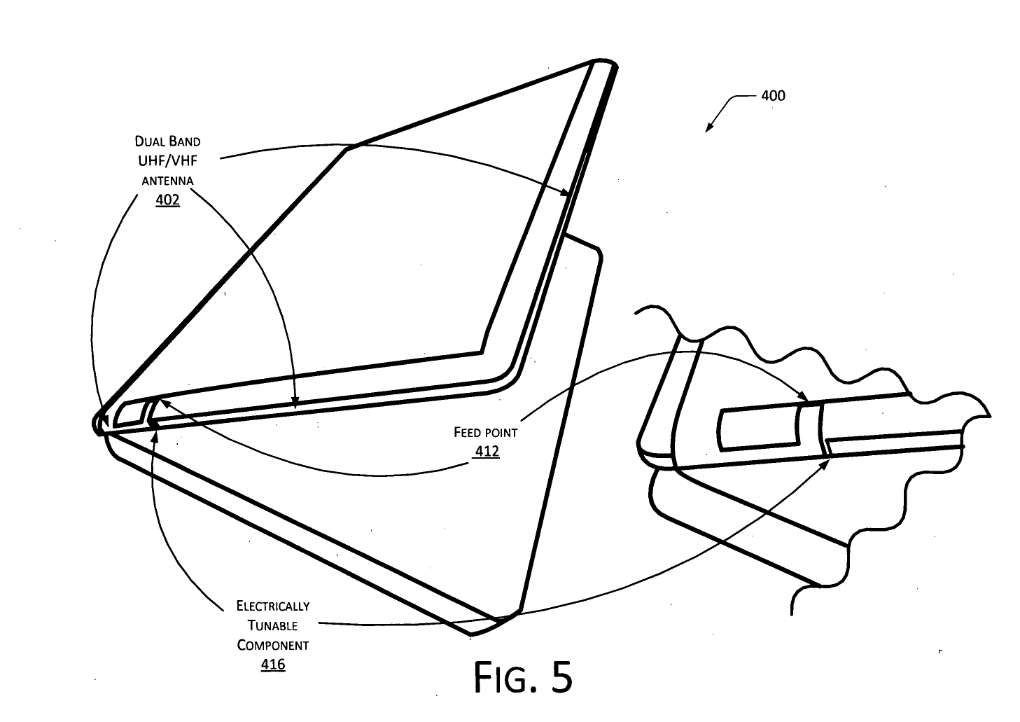

FIG. 5 shows device 400 and the location of the multi-band tunable antenna 402. The alternative view of FIG. 5 shows feed point 412 and location for the electrically tunable component 416.

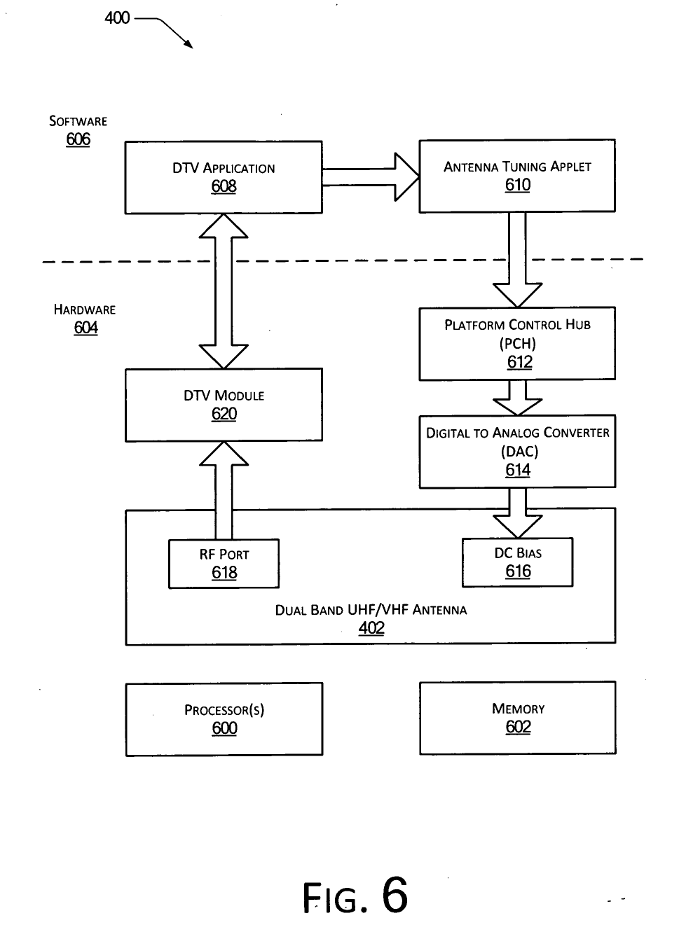

FIG. 6 shows a device 400. The device 400 includes the multi-band tunable to support DTV service/signals. The device 400 can include wireless devices, such as laptops, net books, personal digital assistants (PDAs), e-readers, tablets, smart phones, etc.

Device 400 includes one or more processors 600 and memory 602, where memory 602 is operatively coupled to the processors 600. The processors can directly or indirectly control or are coupled to other devices and components of device 400. In certain implementations, the components and devices that are described herein can be implemented as part of memory 602. Memory 602 can include computer-readable media, which includes computer storage media.

Computer storage media includes volatile and non-volatile, removable and non-removable media implemented in any method or technology for storage of information such as computer readable instructions, data structures, program modules, or other data. Memory 602 and computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

Device 400 in this implementation includes a hardware section 604 and a software section 606, although it is to be understood that in other implementations the described blocks can be integrated as hardware, software, firmware, and/or a combination.

At the software section 606, a DTV application 608 is provided. A function of the DTV application 608 is to report channel change events. A user, or the user's actions, can initiate the channel change event(s).

The DTV application 608 provides reports or informs other components, devices, applications, etc. of device 400 when a channel is changed. The changing of the channel, in particular, affects the need for a specific antenna frequency(ies). In specific, the DTV application 608 provides channel change information to an antenna tuning applet 610. The antenna tuning applet 610 is configured to lookup a corresponding bias voltage to the channel change request. A lookup table, or similar approach, can be configured into the antenna tuning applet 610 to perform such a lookup.

At the hardware section, a platform control hub or PCH 612 is provided. The PCH 612 receives the bias voltage information from the antenna tuning applet 610. A digital to analog converter or DAC 614 is configured to receive a command from the PCH 612 to change bias voltage. In certain implementations the PCH 612 and DAC 614 communicate using interfaces such as general purpose input/output or GPIO and system management bus or SMBUS. In particular, the PCH 612 is used to control output of the DAC 614. The DAC 614 in turn generates a particular bias voltage that corresponds to channel frequency.

As discussed above, in reference to FIG. 2, a DC bias 210, is generated. Such a DC bias 210, is illustrated as DC bias 616 in FIG. 6. The DC bias 616 is generated by the DAC 614 and is included with the multi-band UHF/VHF antenna 402.

The multi-band tunable antenna 402 includes a radio frequency or RF port 618 that communicates with a DTV module 620. The DTV module 620 receives channel change information/data from the multi-band tunable antenna 402 and the DTV application 608.

In an implementation, during operation of DTV services, upon a channel change request is issued from end user, DTV module 620 reports the channel information to the DTV application 608, where information such new channel frequency, DC bias of the varactor (i.e., electrically tunable component) for the selected channel frequency are generated through a lookup table in antenna tuning applet 610. Then the DTV application 608 issues a command to PCH 612, through which a DAC 614 is controlled to output a bias voltage or DC bias 616, through a DC control line to tune the multi-band tunable antenna 402 to the new channel frequency.

In certain cases, a calibration process may be performed for the multi-band tunable antenna 402 when implemented on a different device chassis. In other implementations, an alternative architecture provides that the DAC 614 be embedded or integrated into the DTV module 620 in order to simplify the control architecture, where no external software application may be needed to configure tune the multi-band tunable antenna 402.

### Process to Tune Multi-Band Antenna

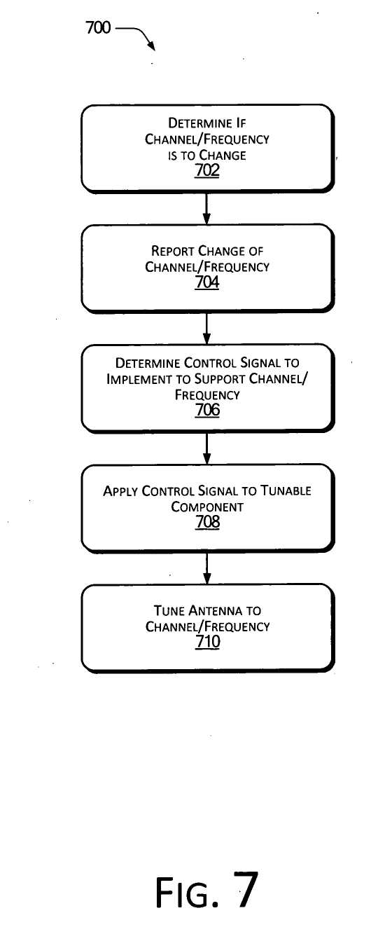

FIG. 7 is a flow chart diagram 700 for an exemplary process for tuning a multi-band tunable for DTV services, for a device. The order in which the method is described is not intended to be construed as a limitation, and any number of the described method blocks can be combined in any order to implement the method, or alternate method. Additionally, individual blocks can be deleted from the method without departing from the spirit and scope of the subject matter described herein. Furthermore, the method can be implemented in any suitable hardware, software, firmware, or a combination thereof, without departing from the scope of the invention.

At block 702, a determination is made if channel or frequency is to be supported and a change made as to a current state of the multi-band tunable antenna. The change may be caused by a user request or action necessitating the change to a different channel or frequency to support a particular DTV signal/service.

At block 704, a report is made as to the change in channel/frequency. The report is provided to other components, applications, modules, etc. that take into account channel or frequency settings, or adjust for channel or frequency changes.

At block 706, a determination is made as to control signal that is used to influence a tunable component, which in turn adjusts reflective properties of elements that the tunable component is connected. In certain implementations, the control signal is a bias voltage that affects a varactor diode. The bias voltage applied to the varactor diode changes the capacitance of the varactor diode and the frequency response of metallic elements connected to the varactor diode, as described above. The control signal (bias voltage) may be determined in a look up table as described above.

At block 708, the control signal is applied to the tunable component, to change the frequency response of the multi-band tunable antenna, in order to properly receive the determined channels/frequencies. In the case of a varactor diode, a bias voltage is the control signal.

At block 710, the antenna is tuned to the channel or frequency. The tuning is particularly for a state, as influenced by the control signal or bias voltage as applied to the tunable component or varactor diode.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims. For example, the systems described could be configured as communication devices, computing devices, and other electronic devices.

What is claimed is:

1. A device comprising:
one or more processors;
memory couple to the one or more processors;
a multi-band tunable antenna that supports UHF and VHF frequencies; and
components controlled by the one or more processors to tune and control the multi-band tunable antenna based on determined frequencies.

2. The device of claim 1, wherein the multi-band tunable antenna supports digital television services and signals.

3. The device of claim 1, wherein the multi-band tunable antenna includes an electrically tunable component and metallic elements, wherein a change in capacitance, inductance, or connectivity to the electrically tunable component changes frequency responses of the metallic elements.

4. The device of claim 3, wherein the electrically tunable component is a varactor diode.

5. The device of claim 1, wherein the components include a DTV module that provides channel or frequency information.

6. The device of claim 1, wherein the components include a DTV application that reports channel or frequency change.

7. The device of claim 1, wherein the components include a platform control hub that receives and passes on bias voltage information to affect a varactor diode that provides a change in capacitance to tune and control the multi-band tunable antenna.

8. The device of claim 1, wherein the multi-band tunable antenna in integrated into a chassis of the device.

9. The device of claim 8, wherein the multi-band tunable antenna is integrated into a lid of the chassis of the device.

10. A wireless device comprising:
a chassis;
a multi-band tunable antenna that supports UHF and VHF frequencies integrated into the chassis, that includes a tunable element, and metallic elements connected by the tunable element, wherein a change to the tunable element changes frequency response of the multi-band tunable antenna.

11. The wireless device of claim 10, wherein the multi-band tunable antenna supports digital television services.

12. The wireless device of claim 10, wherein the multi-band tunable antenna is integrated into the lid of the chassis.

13. The wireless device of claim 10, wherein the tunable element is a varactor diode that receives bias voltage that changes capacitance of the varactor diode and reflective properties of the metallic elements.

14. The wireless device of claim 10, wherein the chassis includes other antennas.

15. The wireless device of claim 10 further comprising a lookup table to provide control signals to the tunable element.

16. The wireless device of claim 10 further comprising digital television module and digital to analog converter that provides bias voltage to the tunable component, wherein the tunable component is a varactor diode.

17. The wireless device of claim 10, wherein the UHF and VHF frequencies support digital television services.

18. A method of tuning a multi-band tunable antenna comprising:
determining if a frequency of the multi-band tunable antenna is to change;
determining a control signal to a tunable component of the tunable dual band antenna that changes reflective properties of the multi-band tunable antenna; and
applying the control signal.

19. The method of claim 10, wherein the frequency is in the UHF and VHF bands.

20. The method of claim 18 wherein the control signal is a bias voltage and the tunable component is a varactor diode.
